(19) United States
(12) Patent Application Publication
(10) Pub. No.: US 2025/0342370 A1
(43) Pub. Date: Nov. 6, 2025

(54) EDGE DEPLOYMENT OF A MIXTURE OF EXPERTS (MoE) ARCHITECTURE

(71) Applicant: Intel Corporation, Santa Clara, CA (US)

(72) Inventor: Akhilesh Thyagaturu, Ruskin, FL (US)

(73) Assignee: Intel Corporation, Santa Clara, CA (US)

(21) Appl. No.: 19/268,617

(22) Filed: Jul. 14, 2025

(51) Int. Cl. G06N 5/022; G06F 9/445

(52) U.S. Cl. CPC G06N 5/022; G06F 9/445

(57) ABSTRACT

A plurality of expert models selected from a mixture of experts (MoE) architecture are launched on a plurality of edge nodes to perform an application workload. Preprocessing to be performed on input data of the application is determined based on the plurality of expert models, where the input data is preprocessed to generate a plurality of different versions of the input data and the plurality of different versions are adapted to inputs of the plurality of expert models. Post-processing to be performed to convert outputs of the plurality of expert models into an end result for the application is determined based on the input data. Additional instances of one or more of the plurality of expert models are dynamically launched on one or more edge nodes based on a service level for the application or a trend identified in the input data.

### BACKGROUND

Computing architectures continue to evolve, with distributed computing environments playing an increasingly prominent role in the development of new and improved computing applications. Such architectures may include cloud computing, edge computing, machine-to-machine, and Internet of Things (IoT) systems, among other examples. With these new applications and architectures and the expansion of computing into automotive, robotics, and artificial intelligence, computer-driven tasks that have low latency demands are also increasing.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 illustrates a simplified block diagram illustrating example components of a data center.

FIG. 2 illustrates a simplified block diagram illustrating an example computing system.

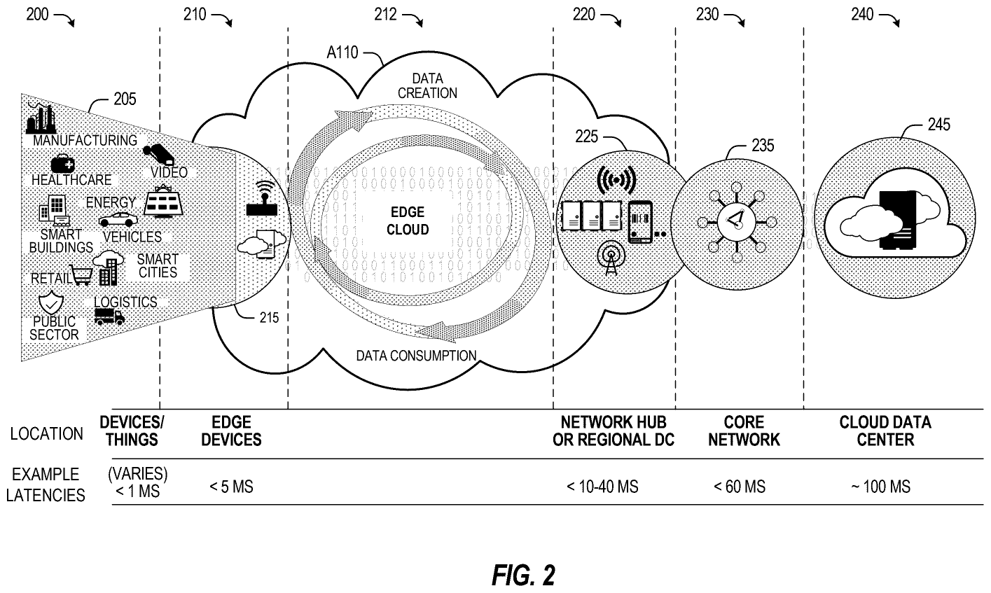

FIG. 3 is a simplified block diagram illustrating an example approach for networking and services in an edge computing system.

FIG. 4 illustrates a simplified block diagram illustrating an example computing device.

FIG. 5 illustrates an overview of layers of distributed compute deployed among an edge computing system.

FIG. 6 is a block diagram representing an example mixture of experts (MoE) solution.

FIG. 7 is a simplified block diagram illustrating an example MoE implementation.

FIG. 8 is a simplified block diagram illustrating establishing an example MoE implementation in an edge system.

FIG. 9 is a simplified block diagram illustrating an example edge deployment of an example MoE-based video processing pipeline.

FIG. 10 is a simplified block diagram illustrating example input data preprocessing for a MoE-based processing solution.

FIG. 11 is a simplified block diagram illustrating example scaling of an implementation of a MoE-based processing pipeline.

FIG. 12 is a simplified block diagram illustrating an example edge implementation of an example MoE-based solution.

FIG. 13 is a simplified block diagram illustrating an example end-to-end application including edge-based processing pipelines.

FIG. 14 is a simplified block diagram illustrating example communication architecture for distribution of data in an implementation of an example MoE-based solution.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

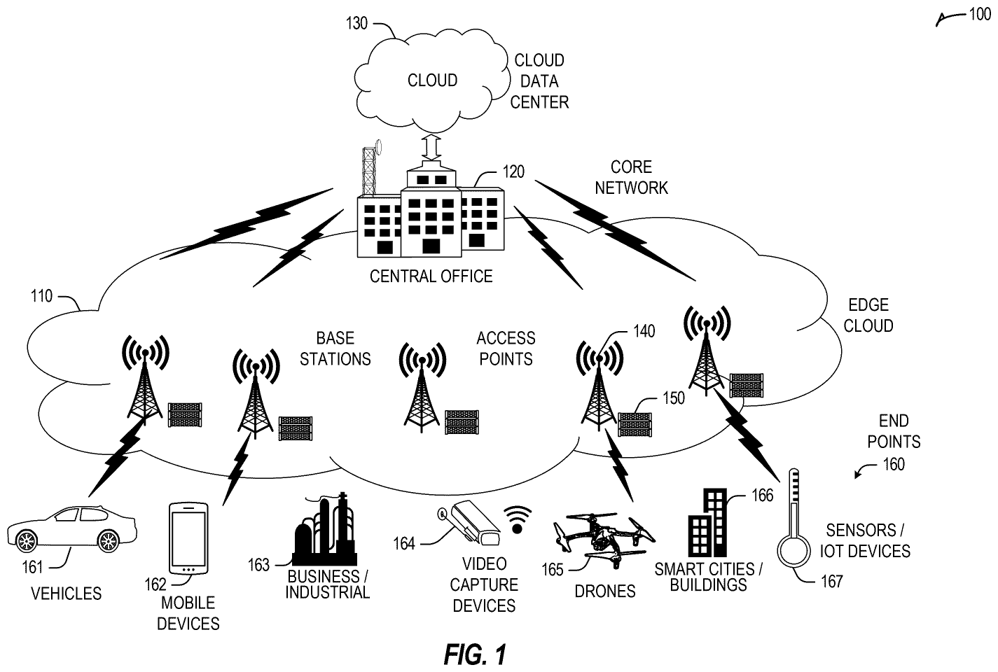

FIG. 1 is a block diagram 200 showing an example computing system, which may implement an internet of things (IoT), edge, or other distributed computing environment and associated communication networks. Access points, such as implemented as base stations 140, in an edge cloud or edge system, a local processing hub 150, or a central office 120. Various data sources 160 (e.g., autonomous vehicles 161, user equipment 162, business and industrial equipment 163, video capture devices 164, drones 165, smart cities and building devices 166, sensors and IoT devices 167, etc.) may be provided in the system and may utilize an edge or access layer to access a cloud data center 130. Compute, memory, and storage resources of the various endpoints, edge devices or access points, and the cloud may be leveraged to implement various applications and solutions.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

At a more generic level, an edge computing system may be described to encompass any number of deployments at the previously discussed layers operating in the edge cloud 110 (network layers 200-240), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, an edge system (or edge cloud) 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks, etc.) may also be utilized in place of or in combination with such 3GPP carrier networks.

The network components of the edge cloud 110 may be servers, multi-tenant servers, appliance computing devices, and/or any other type of computing devices. For example, the edge cloud 110 may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., electromagnetic interference (EMI), vibration, extreme temperatures, etc.), and/or enable submergibility. Example housings and/or surfaces thereof may include or connect to mounting hardware to enable attachment to structures such as buildings, telecommunication structures (e.g., poles, antenna structures, etc.), and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, infrared or other visual thermal sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, rotors such as propellers, etc.) and/or articulating hardware (e.g., robot arms, pivotable appendages, etc.). In some circumstances, the sensors may include any type of input devices such as user interface hardware (e.g., buttons, switches, dials, sliders, microphones, etc.). In some circumstances, example housings include output devices contained in, carried by, embedded therein and/or attached thereto. Output devices may include displays, touchscreens, lights, light-emitting diodes (LEDs), speakers, input/output (I/O) ports (e.g., universal serial bus (USB)), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. The edge cloud 110 may also include one or more servers and/or one or more multi-tenant servers. Such a server may include an operating system and implement a virtual computing environment. A virtual computing environment may include a hypervisor managing (e.g., spawning, deploying, commissioning, destroying, decommissioning, etc.) one or more virtual machines, one or more containers, etc. Such virtual computing environments provide an execution environment in which one or more applications and/or other software, code, or scripts may execute while being isolated from one or more other applications, software, code, or scripts.

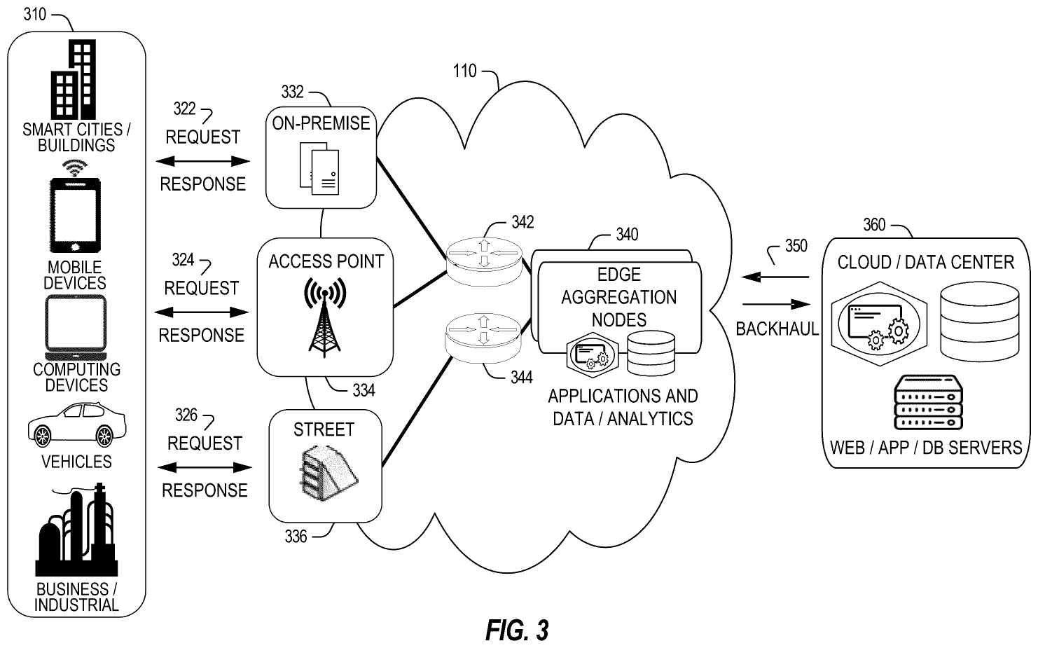

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., a cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

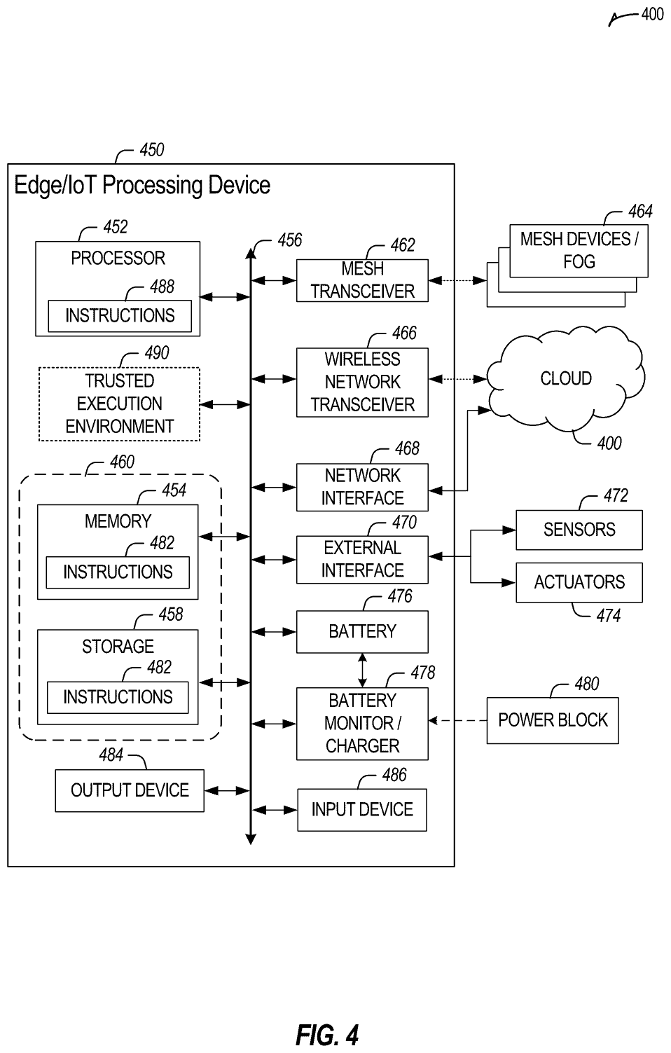

FIG. 4 is a block diagram of an example of components that may be present in an example IoT, edge, or endpoint computing device 450, which may include logic for implementing the techniques described herein. For instance, the computing device 450 may include any combinations of the components shown in the example or referenced in the disclosure above. The components may be implemented as integrated circuits (ICs_, intellectual property (IP) blocks (or portions thereof), discrete electronic devices, or other modules, logic, hardware, software, firmware, or a combination thereof adapted in the computing device 450, or as components otherwise incorporated within a chassis of a larger system. Additionally, the block diagram of FIG. 4 is intended to depict a high-level view of components of the computing device 450. However, some of the components shown may be omitted, additional components may be present, and different arrangement of the components shown may occur in other implementations.

The computing device 450 may include processor circuitry in the form of, for example, a processor 452, which may be a microprocessor, a multi-core processor, a multithreaded processor, an ultra-low voltage processor, an embedded processor, or other known processing elements. The processor 452 may be a part of a system on a chip (SoC) in which the processor 452 and other components are formed into a single integrated circuit, or a single package. The processor 452 may communicate with a system memory 454 over an interconnect 456 (e.g., a bus). Any number of memory devices may be used to provide a given amount of system memory. To provide persistent storage of information such as data, applications, operating systems and so forth, a storage 458 may also couple to the processor 452 via the interconnect 456. In an example the storage 458 may be implemented via a solid state disk drive (SSDD). Other devices that may be used for the storage 458 include flash memory cards, such as SD cards, microSD cards, XD picture cards, and the like, and USB flash drives. In low power implementations, the storage 458 may be on-die memory or registers associated with the processor 452. However, in some examples, the storage 458 may be implemented using a micro hard disk drive (HDD). Further, any number of new technologies may be used for the storage 458 in addition to, or instead of, the technologies described, such resistance change memories, phase change memories, holographic memories, or chemical memories, among others.

The components may communicate over the interconnect 456. The interconnect 456 may include any number of technologies, including PCI express (PCIe), Compute Express Link (CXL), NVLink, HyperTransport, or any number of other technologies. The interconnect 456 may be a proprietary bus, for example, used in a SoC based system. Other bus systems may be included, such as an I2C interface, an SPI interface, point to point interfaces, and a power bus, among others.

Given the variety of types of applicable communications from the device to another component or network, applicable communications circuitry used by the device may include or be embodied by any one or more of components 462, 466, 468, or 470. Accordingly, in various examples, applicable means for communicating (e.g., receiving, transmitting, etc.) may be embodied by such communications circuitry. For instance, the interconnect 456 may couple the processor 452 to a mesh transceiver 462, for communications with other mesh devices 464.

The mesh transceiver 462 may use any number of frequencies and protocols, such as 2.4Gigahertz (GHz) transmissions under the IEEE 802.15.4 standard, using the Bluetooth® low energy (BLE) standard, as defined by the Bluetooth® Special Interest Group, or the ZigBee® standard, among others. The mesh transceiver 462 may communicate using multiple standards or radios for communications at different ranges.

A wireless network transceiver 466 may be included to communicate with devices or services in the cloud 400 via local or wide area network protocols. For instance, the edge device 450 may communicate over a wide area using LoRaWAN™ (Long Range Wide Area Network), among other example technologies. Indeed, any number of other radio communications and protocols may be used in addition to the systems mentioned for the mesh transceiver 462 and wireless network transceiver 466, as described herein. For example, the radio transceivers 462 and 466 may include an LTE or other cellular transceiver that uses spread spectrum (SPA/SAS) communications for implementing high speed communications. Further, any number of other protocols may be used, such as Wi-Fi® networks for medium speed communications and provision of network communications. A network interface controller (NIC) 468 may be included to provide a wired communication to the cloud 400 or to other devices, such as the mesh devices 464. The wired communication may provide an Ethernet connection, or may be based on other types of networks, protocols, and technologies.

The interconnect 456 may couple the processor 452 to an external interface 470 that is used to connect external devices or subsystems. The external devices may include sensors 472, such as accelerometers, level sensors, flow sensors, optical light sensors, camera sensors, temperature sensors, a global positioning system (GPS) sensor, pressure sensors, barometric pressure sensors, and the like. The external interface 470 further may be used to connect the edge device 450 to actuators 474, such as power switches, valve actuators, an audible sound generator, a visual warning device, and the like.

In some optional examples, various input/output (I/O) devices may be present within, or connected to, the edge device 450. Further, some edge computing devices may be battery powered and include one or more batteries (e.g., 476) to power the device. In such instances, a battery monitor/charger 478 may be included in the edge device 450 to track the state of charge (SoCh) of the battery 476. The battery monitor/charger 478 may be used to monitor other parameters of the battery 476 to provide failure predictions, such as the state of health (SoH) and the state of function (SoF) of the battery 476, which may trigger an edge system to attempt to provision other hardware (e.g., in the edge cloud or a nearby cloud system) to supplement or replace a device whose power is failing, among other example uses.

The storage 458 may include or be loaded with instructions 482 in the form of software, firmware, or hardware commands to implement the workflows, services, microservices, or applications to be carried out in transactions of an edge system, including techniques described herein. Although such instructions 482 are shown as code blocks included in the memory 454 and the storage 458, it may be understood that any of the code blocks may be replaced with hardwired circuits, for example, built into an application specific integrated circuit (ASIC). In some implementations, hardware of the edge computing device 450 (separately, or in combination with the instructions 488) may configure execution or operation of a trusted execution environment (TEE) 490. In an example, the TEE 490 operates as a protected area accessible to the processor 452 for secure execution of instructions and secure access to data, among other example features.

Some elements within a data center environment, an IoT environment, or autonomous industrial or transportation environment (among other examples, may be particularly latency sensitive. For instance, an autonomous vehicle or robot may need to process large amounts of environment information in near-real time (e.g., as observed by a human riding in the vehicle or interacting with the drone or robot) in order to operate accurately and safely. Other workloads, such as handled in a datacenter, IoT, or edge computing environment may also demand that certain specialized processing capabilities (e.g., of a specialized processor (e.g., a graphics processing unit (GPU), tensor processing unit (TPU), smart networking elements (e.g., an infrastructure processing unit (IPU), a precision time accelerator (e.g., implementing a

Precision Time Protocol or other time-precise controller), machine learning accelerator, or other hardware accelerator device) may be leveraged to process data with low latency tolerances (e.g., based on the purpose or demands of the application (e.g., controlling autonomous interactions with the physical world, media processing, etc.), a service level agreement, or other example aspects of a workload.

To assist in meeting more aggressive latency demands, some systems utilize Time Sensitive Network (TSN) protocols and principles, among other enhanced low latency networking features, to assist in delivering data associated with time-sensitive workloads to general processing and accelerator devices. Indeed, with the advent of TSN standards, automotive applications are increasingly integrating TSN-capable Ethernet controllers. Time sensitive networking provides precise scheduling of data and scalability while reducing the wiring weight and cost. For example, in autonomous driving applications, high bandwidth, high resolution camera data is transmitted over a base-T1 Ethernet network before it is processed by a GPU (or other processing device). In the case of the automotive applications, GPUs are typically used for real-time object detection and identification, sensor fusion, and image processing. Hence, high bandwidth memory (HBM) is often used in conjunction with graphics accelerators for these applications.

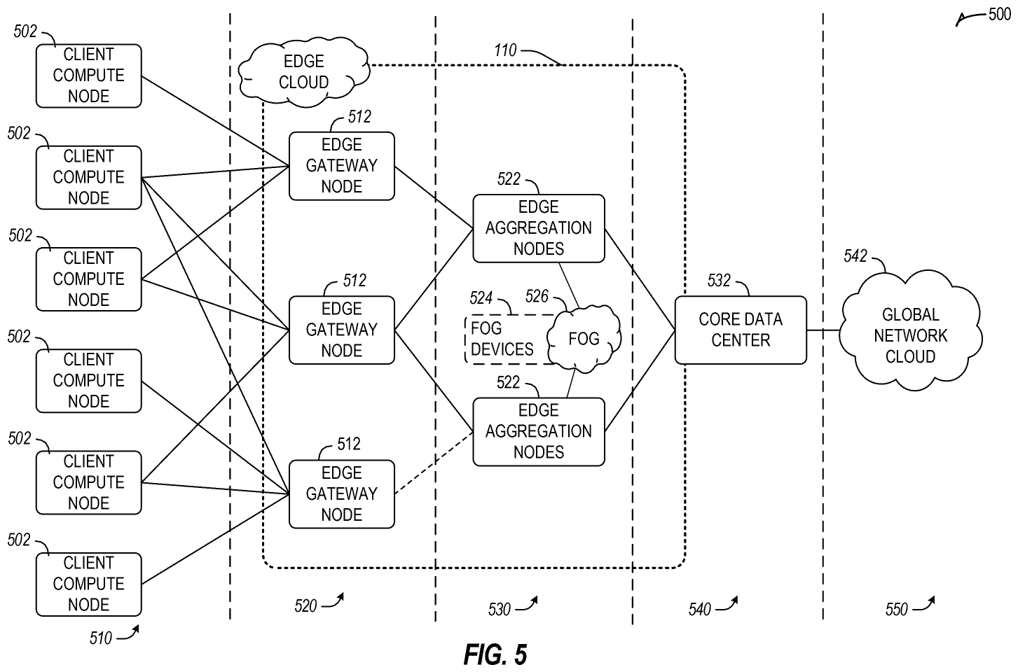

FIG. 5 generically depicts an edge computing system for providing edge services and applications to various entities, as distributed among one or more client compute nodes 502, one or more edge gateway nodes 512, one or more edge aggregation nodes 522, one or more core data centers 532, and a global network cloud 542, as distributed across layers of the network. The implementation of the edge computing system may be provided at or on behalf of a telecommunication service provider (“telco”, or “TSP”), internet-of-things service provider, cloud service provider (CSP), enterprise entity, or any other number of entities.

Edge nodes in an edge computing system can be respectively located at one of a variety of layers 510, 520, 530, 540, 550 of the system. For example, the client compute nodes 502 are each located at an endpoint layer 510, while edge gateway nodes 512 are located at an edge devices layer 520 (local level) of the edge computing system. Additionally, edge aggregation nodes 522 (and/or fog devices 524, if arranged or operated with or among a fog networking configuration 526) are located at a network access layer 530 (an intermediate level). Fog computing (or “fogging”) may generally refer to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein are applicable to fog networks, fogging, and fog configurations. Further, aspects of the edge computing systems discussed herein may be configured as a fog, or aspects of a fog may be integrated into an edge computing architecture.

The core data center 532 is located at a core network layer 540 (e.g., a regional or geographically-central level), while the global network cloud 542 is located at a cloud data center layer 550 (e.g., a national or global layer). The use of “core” is provided as a term for a centralized network location-deeper in the network-which is accessible by multiple edge nodes or components; however, a “core” does not necessarily designate the “center” or the deepest location of the network. Accordingly, the core data center 532 may be located within, at, or near the edge cloud 110.

Although an illustrative number of client compute nodes 502, edge gateway nodes 512, edge aggregation nodes 522, core data centers 532, global network clouds 542 are shown in FIG. 5, it should be appreciated that the edge computing system may include more or fewer devices or systems at each layer. Additionally, as shown in FIG. 5, the number of components of each layer 510, 520, 530, 540, 550 generally increases at each lower level (i.e., when moving closer to endpoints). As such, one edge gateway node 512 may service multiple client compute nodes 502, and one edge aggregation node 522 may service multiple edge gateway nodes 512.

Consistent with the examples provided herein, each client compute node 502 may be embodied as any type of end point component, device, appliance, or “thing” capable of communicating as a producer or consumer of data. Further, the label “node” or “device” as used in the edge computing system 500 does not necessarily mean that such node or device operates in a client or agent/minion/follower role; rather, any of the nodes or devices in the edge computing system 500 refer to individual entities, nodes, or subsystems which include discrete or connected hardware or software configurations to facilitate or use the edge cloud 110.

As such, the edge cloud 110 may be formed from network components and functional features operated by and within the edge gateway nodes 512 and the edge aggregation nodes 522 of layers 520, 530, respectively. The edge cloud 110 may be embodied as any type of network that provides edge computing and/or storage resources which are proximately located to radio access network (RAN) capable endpoint devices (e.g., mobile computing devices, IoT devices, smart devices, etc.), which are shown in FIG. 5 as the client compute nodes 502. In other words, the edge cloud 110 may be envisioned as an “edge” which connects the endpoint devices and traditional mobile network access points that serves as an ingress point into service provider core networks, including carrier networks (e.g., Global System for Mobile Communications (GSM) networks, Long-Term Evolution (LTE) networks, 5G networks, etc.), while also providing storage and/or compute capabilities. Other types and forms of network access (e.g., Wi-Fi, long-range wireless networks) may also be utilized in place of or in combination with such 3GPP carrier networks.

In some examples, the edge cloud 110 may form a portion of or otherwise provide an ingress point into or across a fog networking configuration 526 (e.g., a network of fog devices 524, not shown in detail), which may be embodied as a system-level horizontal and distributed architecture that distributes resources and services to perform a specific function. For instance, a coordinated and distributed network of fog devices 524 may perform computing, storage, control, or networking aspects in the context of an IoT system arrangement. Other networked, aggregated, and distributed functions may exist in the edge cloud 110 between the cloud data center layer 550 and the client endpoints (e.g., client compute nodes 502). Some of these are discussed in the following sections in the context of network functions or service virtualization, including the use of virtual edges and virtual services which are orchestrated for multiple stakeholders.

The edge gateway nodes 512 and the edge aggregation nodes 522 cooperate to provide various edge services and security to the client compute nodes 502. Furthermore, because each client compute node 502 may be stationary or mobile, each edge gateway node 512 may cooperate with other edge gateway devices to propagate presently provided edge services and security as the corresponding client compute node 502 moves about a region. To do so, each of the edge gateway nodes 512 and/or edge aggregation nodes 522 may support multiple tenancy and multiple stakeholder configurations, in which services from (or hosted for) multiple service providers and multiple consumers may be supported and coordinated across a single or multiple compute devices.

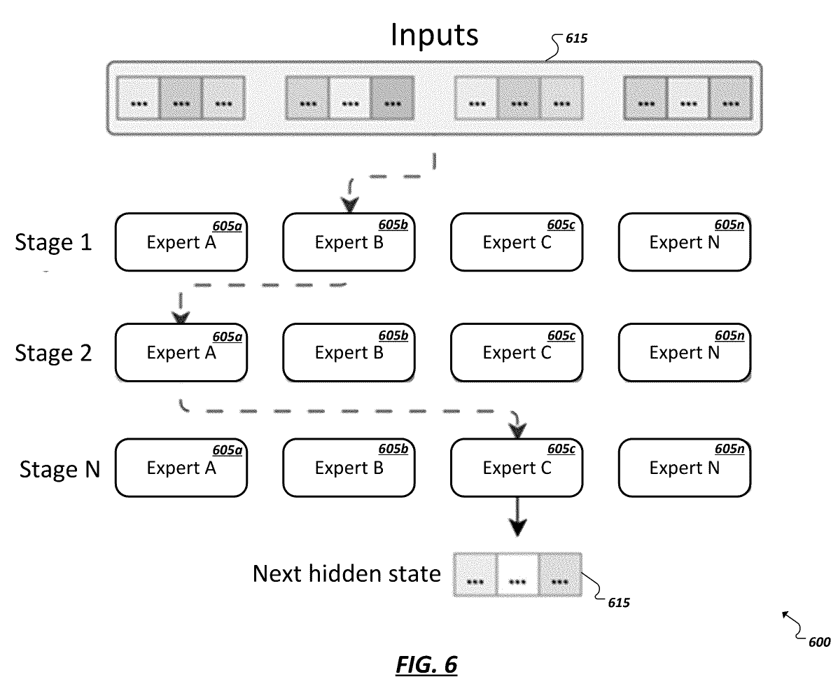

FIG. 6 is a simplified block diagram 600 illustrating an example Mixture of Experts (MoE) machine learning architecture. MoE architectures include multiple specialized sub-models (or “experts” (e.g., 605a-n)), which are respectively trained to perform inferences on a particular type of data, region of data (e.g., region of an image or video frame), and/or learn and identify particular features or patterns. The respective MoE expert models may be implemented as individual neural network models (e.g., convolutional neural network (CNN) models, multilayer perceptron (MLP), transformer models, or other machine learning models) and the MoE architecture may include an implementation of a gating network through which specific MoE expert models are selected to be used to contribute results to a final outputs (based on inputs 610). The gating network may be used to select which of the MoE models are to be used (and have input data 610 fed to) to generate an aggregate result, for instance, for use by an end user or other application. In some implementations, the gating network may be implanted as a weighted network, where identifies weights to be provided to outputs of the respective selected ones of the MoE models to determine the respective contribution the output of that MoE model will have to the final result. The outputs of the selected experts may be combined (e.g., by a weighted sum using the gating network's weighting) to produce a final model output.

As an illustrative example, an MoE architecture may include a library of MoE expert models, trained to perform inferences connected to various jobs, data, or purposes within one or more use cases or application contexts. For instance, in a smart manufacturing use case, the MoE expert models may include a vision expert (e.g., trained to detect defects in a product that is to be assembled or in the operation of a machine that is to be used), a vibration expert (e.g., to detect anomalies or failure in a machine), and natural language processing (NLP) expert (e.g., to perform analysis of log entries or other text generated in connection with the manufacturing activities or reporting), among other examples. In such an example use case, the vision expert (e.g., 605b) may detect a potential defect in a stream of image or video data and the gating network may be configured to activate the vibration expert (e.g., 605a) and NLP expert (e.g., 605c) visual stream. The vibration expert and NLP expert may be used, in this example, to determine if features detected by the vision expert correlate with abnormal vibrations and/or log messages, in order to derive a final inference indicating whether to stop production or send an alert to the operator (e.g., which may be sent to another hidden layer, state, or system logic (e.g., 615).

In some example implementations, a MoE architecture may be implemented using nodes of an example edge computing system. For instance, through the activation of certain relevant experts by the gating network, for instance, based at least in part on local data context, respective activated expert models may be deployed and implemented on respective edge node devices, for instance, to improve inference speed and resource usage on constrained edge devices. In some implementations, respective edge nodes may be equipped with a single (or where resources are sufficient, multiple) lightweight, specialized expert models trained for specific tasks or data modalities (e.g., vision, audio, anomaly detection). Further, edge nodes may also be used to implement one or multiple gating nodes to include a lightweight controller function (in hardware or software) to implement the gating network of the MoE architecture and determine which experts (e.g., local or remote) to activate for a given task. In some implementations, an inter-node communication layer may be provided, for instance, implemented as a low-latency communication protocol (e.g., gRPC over 5G/MQTT/LoRaWAN) enabling nodes to query and activate remote experts. Further, one or more edge nodes may be used to implement an inference aggregator for the MoE architecture and collects expert outputs and fuse them (e.g., via attention, consensus voting, weighted summation, or another technique) to generate final predictions/actions.

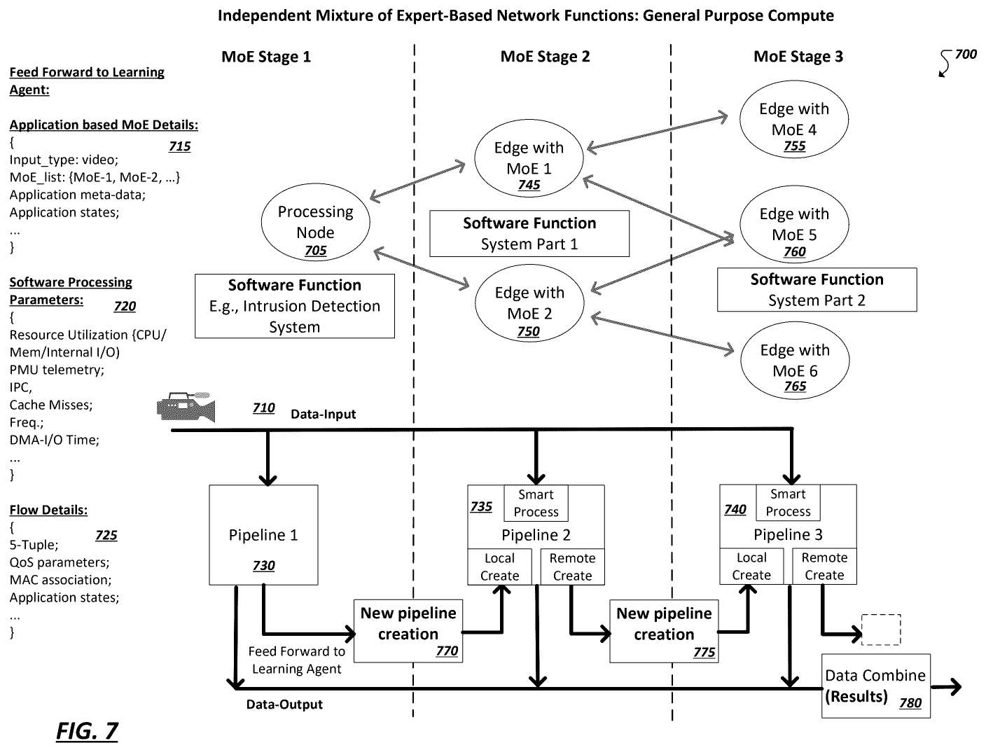

FIG. 7 is a simplified block diagram 700 illustrating an example implementation of an MoE architecture in an edge computing system. In this example, a processing node 705 (which may be implemented as user compute node, cloud compute node, or even another edge node) may provide information to identify a purpose or objective of an example application (e.g., intrusion detection, anomaly detection, human persona identification, etc.) and this information (e.g., 715) may be used (e.g., by a gating network node) to identify a set of expert model in the MoE architecture to invoke as well as an ordering or interdependency between the selected expert models (e.g., where the output of one model may be suitably used as an input or to refine the input (e.g., through segmentation or bounding of the input data) of another one of the selected expert models) to be used to generate a requested or desired end result for the application. Various data inputs (e.g., 710) may be identified associated with the application and the workflow(s) to be implemented utilizing the selected MoE expert models. The nature and sources of this data (e.g., which may be acquired from one or multiple sensors or sub-systems) may also be analyzed to determine the appropriate selection of MoE expert models, as well as any preprocessing of the data (e.g., transformation, resizing, conversion, segmentation, duplication, masking or deletion, etc.) to adapt the data to be suitable inputs to respective expert models in the MoE architecture. Additionally, processing parameters (e.g., 720) and flow details (e.g., 725) may be specified or determined for the workflows to determine, for instance, any quality of service policies, hardware requirements (or limits), telemetry features or demands, application states, interconnect features, or other features or policies, which should be considered in the implementation and deployment of the selected MoE expert models. Based on these policies, the nature and logic used to implement the selected expert models, and the nature of the data to be used by the application (e.g., including localization of the data and/or host of the application processing node), a select subset of edge nodes (e.g., within a corresponding geographic locality) may be identified that would be equipped with the resources (e.g., compute capabilities, memory capabilities, networking and interconnect capabilities, etc.) to host and execute the selected expert models.

Continuing with the example of FIG. 7, a number of processing pipelines (e.g., 730, 735, 740) may be determined to implement a sequence, chain, or tree of MoE expert models selected to implement a given end result. For instance, based on the availability of edge resources, the nature and characteristics of the input data 710, and policies that are to be applied to the requesting application, a number of edge nodes (e.g., 745, 750, 755, 760, 765, etc.) may be selected and logic may be deployed on the edge nodes to implement respective selected MoE expert models. In some cases, analysis of the data and the edge resources may allow for dynamic scaling and deployment of additional edge node resources and pipelines (e.g., at 770, 775) to improve execution efficiency and adapt to the potentially changing nature of the input data 710 that is fed into the MoE to generate an aggregated result (e.g., 780).

In one example, user inputs may be provided (e.g., in connection with an application calling upon the MoE architecture), where a user, autonomous agent, or application logic specifies parameters for use in determining a set of MoE expert models or selects the desired processing MoE expert models (e.g., respective models trained to estimate age, determine height, or other characteristics of a human in a security application, among other examples) based on their end goal. Data capture may be implemented (e.g., by the application) to direct input data (e.g., a captured image frame from a camera sensor) to be used as inputs in the MoE architecture. In some implementations, data analysis may be performed to adapt the collected data to the selected expert models, for instance, by preprocessing the data (e.g., to preprocess an image frame through resizing, color conversion, cropping, etc.) and to analyze the processed data to confirm or refine the selected MoE experts.

In some implementations, the input data can be prepared for various MoE expert models as well as the scaling of the MoE architecture (e.g., to implement parallel versions of the MoE experts on multiple edge nodes). For instance, data splitting and distribution may be performed, such as to segment a single image frame into multiple regions of interest, with different MoE experts corresponding to the different regions (e.g., a region corresponding to an animal detected in the image frame is passed to an expert for identifying the type of animal, whereas a different region corresponding to a human is sent to a different expert model for associated inferencing (e.g., height, gait, gender, etc.). Alternatively, a single image may be segmented to provide multiple inputs to the same MoE expert. As an example, an image including multiple faces may be segmented to generate multiple inputs, with each of the multiple inputs including a portion of the image data corresponding to one of the detected faces. The multiple face image segments may be provided serially as inputs to the edge node hosting an expert that is to perform an inference (e.g., a facial features expert) on a face image. In other instances, multiple parallel instances of the expert may be launched on multiple edge nodes so as to allow the segments to be processed in parallel by the multiple expert instances. Indeed, in some implementations, a pattern or trend may be identified within the data to identify the prevalence of input data including multiple segments processable by the same expert model to cause multiple instances of the expert model to be provisioned within an edge system (proactively). In some situations, all or a select portion of the data (e.g., an image frame) may be replicated such as where segmentation is not feasible (and the data is to be input to different expert models in parallel), or to allow parallel processing of the image data by multiple MoE expert models (e.g., hosted on different systems (e.g., edge nodes)), among other examples.

In an example implementation where the MoE expert models are to be launched on one or more edge nodes, based on the selected or activated MoE expert models and the data (e.g., where it amenable to segmentation, replication, or other parallel processing), a suitable number of edge nodes (e.g., equipped to execute the selected MoE expert models) may be identified in a system and the MoE expert model logic may be launched on the edge nodes to implement the MoE. Accordingly, the corresponding data fragment(s) and associated MoE expert models may be sent to the chosen edge node(s) used to implement the expert models. The receiving edge nodes may then independently perform corresponding inference using the appropriate model and generate a corresponding output. These inference output results (e.g., age estimation, height estimation, etc.) may be collected from the corresponding edge nodes and combined to generate the end results based on the original frame and selected MoE flow. This final output (e.g., combined age and height estimations) may then be delivered to a user or designated system for consumption.

Some edge systems, due to the resource-constrained nature of many edge node devices, may suffer from a variety of performance issues. Generally, edge nodes may be resource constrained and distributed. To implement some workloads, an initial deployment of an edge solution can involve dedicated planning and allocation to implement a statically defined, heavyweight pipeline of execution to meet the lifetime demands defined of a given application. This may be particularly the case where an edge system is provisioned to use the combined resources of the edge nodes to process a large quantum of data. In an improved implementation, an edge system may be provisioned to intelligently break down larger data inputs (e.g., a high resolution image frame, a multi-media file, a large document, etc.) into smaller segments based on a set of MoE expert models selected for a related application. For instance, a given video frame input may be split into multiple segments corresponding to multiple MoE expert models and inferencing on the respective segments may be performed by the corresponding MoE expert model (e.g., a segment corresponding to the image of one of potentially multiple people present in the image may be processed by a first MoE expert to determine the age of the person in the video frame). Further, based on these divisions of data and the workload, the processing pipeline (e.g., as implemented by selected edge nodes provisioned with corresponding MoE expert model logic) may be dynamically provisioned so as to implement MoE-based data processing scaling and replication of services through the distributed edge nodes configured as MoE-compute functions to optimize the end-to-end application Service Level Agreements (SLAs). For instance, dynamic processing pipelines may be implemented using edge nodes based on MoE using end-to-end application requirements, and the input data to the pipelines may be preprocessed to create scaled data (e.g., replicated data, split or segmented data, or other variations on the input data to be routed to respective edge nodes executing respective MoE experts), which can be used to feed additional pipelines that are created in reaction to identifying such split-data inputs and the opportunity to implement scaled parallel processing of the overall workload.

In an improved approach, such as discussed herein, an edge-deployed MoE architecture may be realized with increased efficiency in an end-to-end context, that is application-specific, and adapted to the time of operation through the reduction of latency, enhanced reliability, and improved resource utilization (e.g., improved video processing for an intrusion detection when there is a peak demand during rush hour). Such systems may realize a high degree of concurrency in the processing pipeline, through dynamic service replication augmented by dynamic data replication and segmentation. Accordingly, in some implementations, the improved system may facilitate the adoption of real-time processing for critical applications like telehealth, industrial robotics, and fraud detection where efficient and accurate analytics may be top priorities. For instance, the system may consider an end-to-end application context, and preprocess the data based on the data type and MoE compute operations to be performed, scaling the microservices relative to the data context through adaptive replication of services to create multiple processing pipelines. The system may additionally consider, based on a determined MoE-based workflow, edge node compute resource availability in distributed networks and utilize data post processing to combine the MoE results to meet end-to-end service requirements.

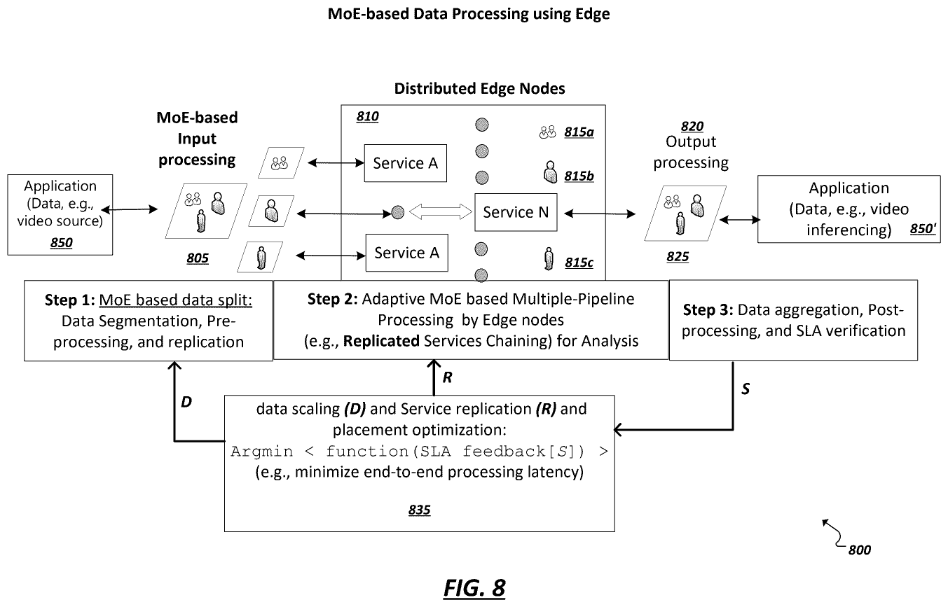

FIG. 8 is a simplified block diagram 800 illustrating an example implementation of dynamic multiple pipeline processing based on a selected MoE-based workflow for an example application 850. The application 850 can provide data to the edge-implemented MoE architecture and the data inputs can be processed (at 805) based on the identified set and flow of MoE experts identified for the application. Such input processing 805 may include identifying opportunities to segment the data and transform the data to serve as suitable inputs to the selected set of MoE experts. Based on the number or volume of data segments that are identified for a single quantum of input data (or the average, trend, or pattern within a stream of data), an orchestrator system 835 with visibility into the input processing 805, application policies (e.g., preferences of the application, SLA or QoS policies for the application, etc.), and the resource availability of edge nodes within a given network, may autonomously determine and initiate the instantiation of a number of MoE expert models on a number of edge nodes in the system of distributed edge nodes 810. For instance, a single pipeline may be instantiated on a number of edge nodes to implement a given MoE flow. The edge nodes may be further configured to implement a data plane or communication between edge nodes to facilitate an MoE flow corresponding to the gating network configuration between the selected MoE expert models. In some cases, opportunities to segment input data and provide multiple segments to a same one of the expert models may be identified. In such cases, multiple instances of the same expert model may be provisioned in the system (e.g., multiple instances on a same edge node or on multiple edge nodes), among other examples. In other cases, multiple instances of the same pipeline may be instantiated within the system to allow parallel pipelines to be implemented (e.g., to process multiple input data in parallel), among other examples. The various outputs (e.g., 815a-c) derived from the individual MoE experts may be provided for output processing 820 to generate end result data 825 based on the combined outputs (e.g., 815a-c). This output 825 may be passed to a consuming application or end user (e.g., 850′), which may be the same or a different application as the application 850 triggering and/or providing input data to the MoE architecture, among other examples.

In some implementations, input data analysis (e.g., 805) may be handled at an edge node in a system, with the edge node analyzing the context of the input data to determine which MoE expert models (in a library or collection of MoE expert models within an architecture) to select to accomplish a particular staged inference workload for an application. Further, preprocessing logic (e.g., code adapted to be executed at the edge node to perform one or more data preprocessing stages to convert the application's input data into inputs suitable for the selected MoE expert models) may be provisioned on one or more edge nodes to perform data preprocessing. For instance, based on the selected MoE models, the input data (e.g., an image frame) can be split into segments (e.g., ROIs) or replicated, for instance, to implement parallel processing of the MoE stages. For instance, the produced input data fragments can be respectively sent to the most suitable edge node for implementing a given MoE model and achieving parallel processing. The respective edge node may perform the associated inference based on its assigned MoE model and the inferred results can be collected and combined based on the original frame and the developed MoE flow to generate a final output to be delivered to another edge node, another system, or other entity.

As noted above, data and application context may be utilized to autonomously determine the MoE flow to accomplish a particular objective, including the constituent MoE expert models to be launched for the flow. For instance, if relying on automated MoE detection from data analysis (at the orchestrator 835), one or more pre-trained or custom-trained classification models may be utilized to categorize the input data based on available MoE experts (e.g., object detection, anomaly detection, etc.) to autonomously determine appropriate MoE models aligned with the characteristics of the data. In some implementations, rule-based systems may be additionally or alternatively used to assess a set of rules that leverages prior knowledge or user preferences to map specific data characteristics to desired MoE models, among other example implementations.

Various preprocessing techniques may be employed to prepare input data to be suitable inputs to the selected MoE expert models in an MoE flow. For instance, data preprocessing models and associated logic may be deployed (e.g., in response to the selection of the set of MoE expert models and determining that various types of preprocessing will be associated with preparing data for use with the expert models) on one or more edge devices in the system. For instance, an orchestrator system or node may provision (e.g., load or install) code and supporting data executable by an edge node to implement a respective expert model on the edge node. As an example, in the case of image input data, image transformation models may be deployed, which are pre-trained models to perform tasks such as resizing, color space conversion, noise reduction, or other preprocessing to prepare the data for inference on various MoE models hosted on other edge nodes. As another example, data augmentation models may be deployed to perform preprocessing to perform data augmentation techniques (e.g., random cropping, flipping, adding Gaussian noise, etc.) to enhance the diversity of training data and improve model robustness.

Edge nodes (e.g., 810) provisioned with MoE expert logic may receive various input data perform inferences on the data. For instance, in the case of object detection expert models various specialized object detection models (e.g., YOLO, SSD, etc.) may be deployed for use in identifying various relevant objects within the received data (e.g., image fragment data), among other examples. Attribute recognition expert models may also be included, for instance, which utilize regression-based models (e.g., ResNet, MobileNet) trained to estimate specific attributes (e.g., age, gender) based on detected objects. Custom MoE expert models may also be available for deployment which are developed and trained tailored to specific inference jobs, among other examples.

Edge nodes within a system may also be utilized to be loaded with result combination logic (e.g., implemented through code generated to be executable to allow the edge node to perform the specific postprocessing determined for a given application workload and MoE flow) to collect the respective outputs of MoE experts and develop an end result (at 820) that aggregates, synthesizes, or otherwise combines results of the set of selected MoE experts. Various result combination models may be selected for use in a given workflow based, for instance, on the nature of the input data and/or the desired result data. For instance, a fusion model may be deployed on an edge node (e.g., in a case where the end result is to be based on multiple object attributes derived by the MoE experts) that intelligently combines outputs from different MoE experts deployed on various edge nodes to enhance accuracy. In another example, rule-based aggregation may be deployed utilizing rule-based logic to merge results based on the original frame structure and user-specified MoE preferences or model selection, among other examples.

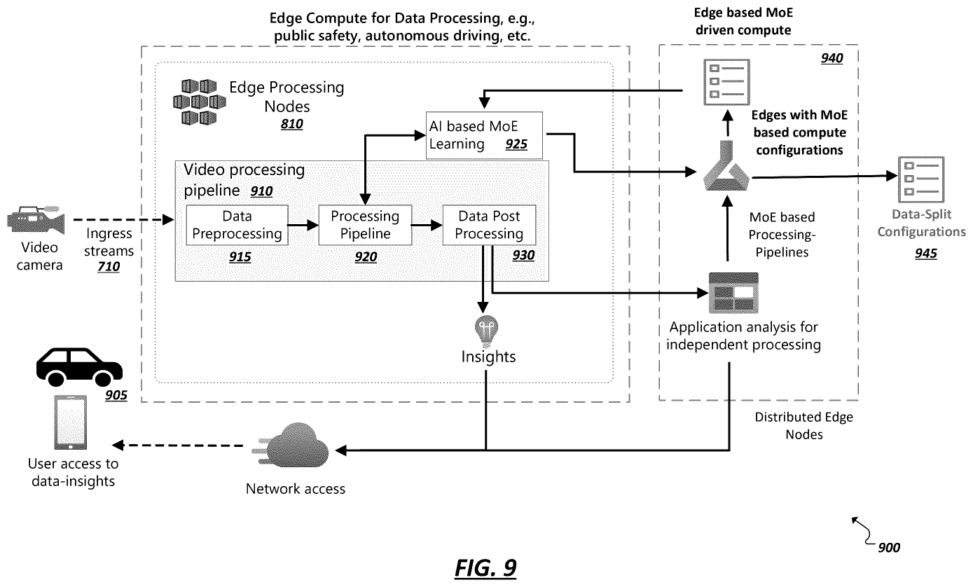

FIG. 9 is a simplified block diagram 900 illustrating an example implementation of an edge system utilized to leverage an MoE workflow to implement a dynamically scalable video processing pipeline 910 within a mobile computing environment (e.g., for a drone, in-vehicle computer vision system, etc.). In mobile implementations, the world of “local” edge nodes 810 may changes as the application's processing node 905 (e.g., an on-board or in-vehicle computer) physical moves within an environment, thus leading to dynamically changing node resources, which may be available for an application (e.g., collision avoidance, object recognition, navigation, etc.). A set of MoE experts may be identified for the application, such as in the examples above, to implement the video processing pipeline within a distributed edge node system 810. The pipeline 910 can include data preprocessing stages 915 to prepare the data for the processing pipeline stage 920, which may be based on the selected subset of MoE expert models 925. Given the selected MoE expert model combination to perform a given job, an orchestrator system can launch a set of edge nodes to implement the MoE expert combination (at 940). In some implementations, the orchestrator system itself may be implemented using one or a combination of the distributed edge nodes. Further, opportunities, policies, and rules for splitting the application's input data may be determined based on MoE expert combination to develop data splitting configurations 945 for the implementation. The orchestrator system may also instantiate one or more edge nodes with logic to implement data post processing 930 for the pipeline 910. The logic and configuration of the data post processing nodes may also be based on or dependent on the selection of the MoE expert models, as the manner in which the outputs are to be combined to developed end results of the pipeline 910 may be dependent on the form of the outputs generated by the constituent MoE expert model stages, among other example considerations.

In some implementations, application and service management may be provided to assist or implement orchestration of the pipeline processes in the edge system. The application and service management may be edge-native and support critical application requirements such as large compute on the data with dedicated end-to-end Service Level Agreements (SLA). Service configuration may be provided to the end users through dedicated interface. A developer framework may also be provided to utilize the dynamic processing pipeline creation. In some implementations, consumable interfaces may be provided for middleware integration such as services can be independently replicated in the intermediate stages of execution (e.g., to implement an SLA spanning multiple staches (e.g., stages A-to-Stage N implemented by multiple MoE nodes). Scalability may be supported and include the ability to dynamically increase or decrease processing capacities through the decomposition of services, which can be placed over distributed edge nodes creating an independent processing pipeline. As such, a creation of a pool of compute resources may be omitted, for instance, where a service function chain to create an independent processing pipeline can be achieved over an independent path of distributed edge compute nodes. In some implementations, data tagging (e.g., time stamp, sequencing, transaction identifiers, etc.) may be utilized (along with other meta data that may be created) at respective MoE expert nodes to synchronize the output and inputs of multiple processing pipelines, and to post-process the data to regenerate the output in the expected format for the end applications.

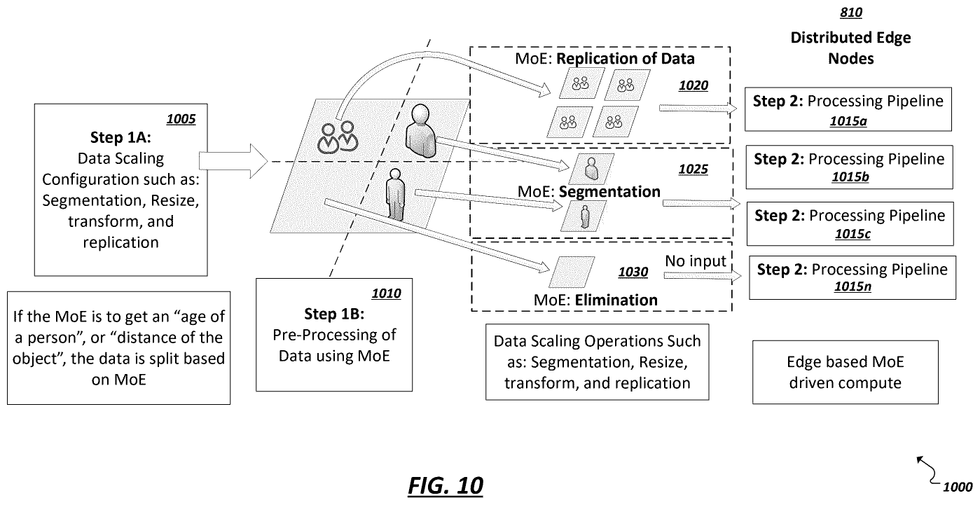

Turning to FIG. 10, a simplified block diagram 1000 is shown illustrating example data modification techniques in association with preparing input data for a certain MoE architecture to be launched in processing pipelines (e.g., 1015a-n) implemented using an edge node network. Data scaling may be based on a configuration determined for a flow of MoE experts determined for a given application workload. Data scaling may be performed as one or more multiple data pre-processing stages, implemented using one or more multiple edges nodes in some implementations. In other instances, data scaling may be performed by the data source or the application itself. Data scaling configuration 1005 may include determining what data segmentation, resizing, transformation, replication, or elimination may be beneficially performed to produce data inputs respective to the various MoE experts that have been selected for a workload. Further, data scaling may be based on application policies, such as SLA or QoS policies, or policies of edge node providers, so as to identify an appropriate amount of edge node resources which might be reserved in order to implement the MoE expert models and whether and to what extent such expert model processing may be implemented and performed in parallel. Based on the configuration, data preprocessing may be performed 1010 and include scaling the data through replication 1015, segmentation 1025, elimination 1030, and any other data scaling stages defined in the data scaling configuration 1005. The scaled data (e.g., 1020, 1025, 1030) may be passed (e.g., from the edge nodes tasked with performing these data pre-processing operations) to the processing pipelines (e.g., 1015a-n) implemented using one or more edge nodes 810 within a system.

As introduced above, in some pre-processing implementations, data replication may be carried out at designated edge nodes. In some cases, centralized and distributed replication strategies may be implemented through simple reinforcement learning, among other examples. In some implementations, data segmentation processing may be performed to segment data to create a unique processing pipeline, such as looking only at a particular group or collection of features, selecting a specific feature set, or working on a background to facilitate the auxiliary information to the overall analysis, among other examples. Through data tagging, consistency and synchronization may be maintained. For instance, as data is output by various MoE edge nodes, the result data may be tagged and maintained with consistency among replicated instances by implementing appropriate synchronization mechanisms to ensure that data remains coherent across replicas. Further, in systems supporting dynamic resource scaling within the edge system, replication strategies may also continuously change based on the changing environment, data type, or end-to-end characteristics (e.g., rush hour as opposed to empty captures, changing network conditions, analysis-load levels, and user requests to ensure end-to-end service quality), among other examples.

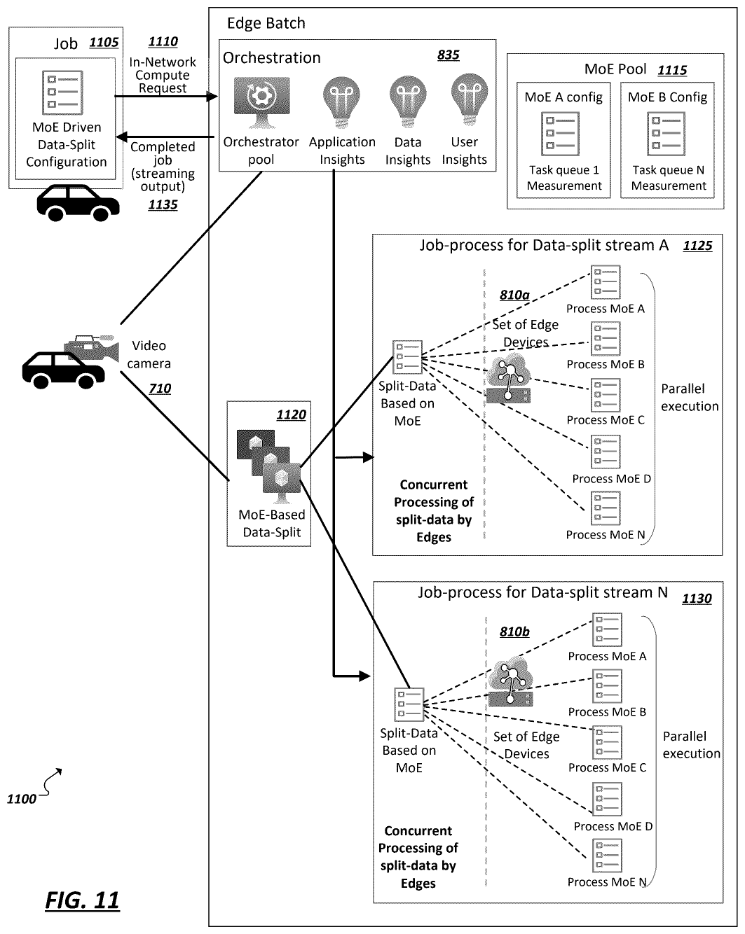

Turning to FIG. 11, a simplified block diagram 1100 is shown illustrating an example implementation of an MoE system capable of concurrent processing of split or segmented data by multiple sets of edge nodes provisioned to implement experts in the MoE system. In the particular example of FIG. 11, the edge deployment of the example MoE system is to implement an end-to-end application to support autonomous driving. Other implementations may apply similar principles in connection with the implementation of a variety of other end-to-end application, including intrusion detection, retail analytics, smart manufacturing, health care diagnostics, among other examples.

In the example of FIG. 11, an application may have a job 1105 that is to be performed using an MoE architecture and the application may request 1110 assistance of an orchestrator system 835 to instantiate an edge-based implementation of a chain of MoE experts to perform the job. A library or pool of MoE expert models 1115 may be maintained and the orchestrator 835 may determine, from a job definition or configuration for the job 1105, a subset of MoE expert models and the gating network configuration to define the chain or flow between the expert models. The application attributes, the MoE expert chain, and characteristics of the input data 710 (e.g., a stream of frame data generated by a video camera) may be assessed to determine a MoE-based data split 1120 to be applied to the input data. Based on the MoE expert models selected and the data split configuration for the job 1105, the orchestrator 835 may determine a set of edge device 810a to provision with logic to implement the respective MoE expert models to perform a set of inferences on a quantum of data (e.g., an individual video frame) and derive a combined result for the input from the results of the constituent MoE expert models. The orchestrator 835, in some implementations, may additionally identify opportunities to scale the implementation such that multiple frames or streams of data may be processed in parallel and may cause multiple sets of edge nodes to be provisioned with duplicate sets of MoE expert logic such that corresponding inferences may be performed on multiple data in parallel. For instance, a first pipeline 1125 may be established to perform the MoE flow for a first steam of data by deploying MoE expert logic on a first set of edge device 810a, while a second pipeline 1125 may be established to perform the MoE flow for a second steam of data by deploying similar MoE expert logic on a second set of edge device 810b. Results generated through the pipelines may be returned 1135 to the requesting application or to a downstream consumer. Further, if the volume of input data to be processed increases over time, additional pipelines of edge nodes may be instantiated dynamically with the corresponding MoE logic to support further parallelization. Similarly, if the volume of input decreases, a processing pipeline may be decommissioned to free up corresponding edge nodes for other tasks.

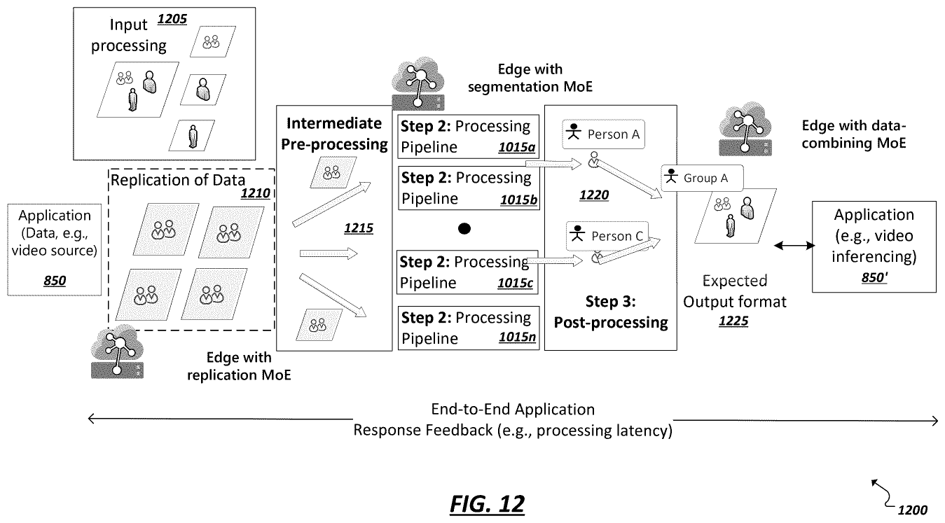

As shown in the simplified block diagram 1200 of FIG. 12, based on or to adapt the system to a scaled implementation of multiple processing pipelines (e.g., dynamically instantiated by an orchestrator system), input data pre-processing 1205 can utilize data replication 1210 to feed multiple instances of data to the various pipelines (e.g., 1015a-n). Further, based on the respective inputs for the MoE experts in various pipelines, intermediate pre-processing 1215 can be employed to apply additional data segmentation or scaling to the respective replicated data to effective nest pre-processing stages (e.g., replicating data followed by performing one or more stages of segmenting, transforming, eliminating, etc. on the respective replicated data instances) before the data is passed as inputs to the edge nodes implementing the instances of the MoE experts in the various pipelines (e.g., 1015a-n). In some cases, outputs generated by the multiple, parallel-processed pipelines may also be returned and post-processed 1220 to derive an end result output 1225 in a format expected by an application (e.g., 850′).

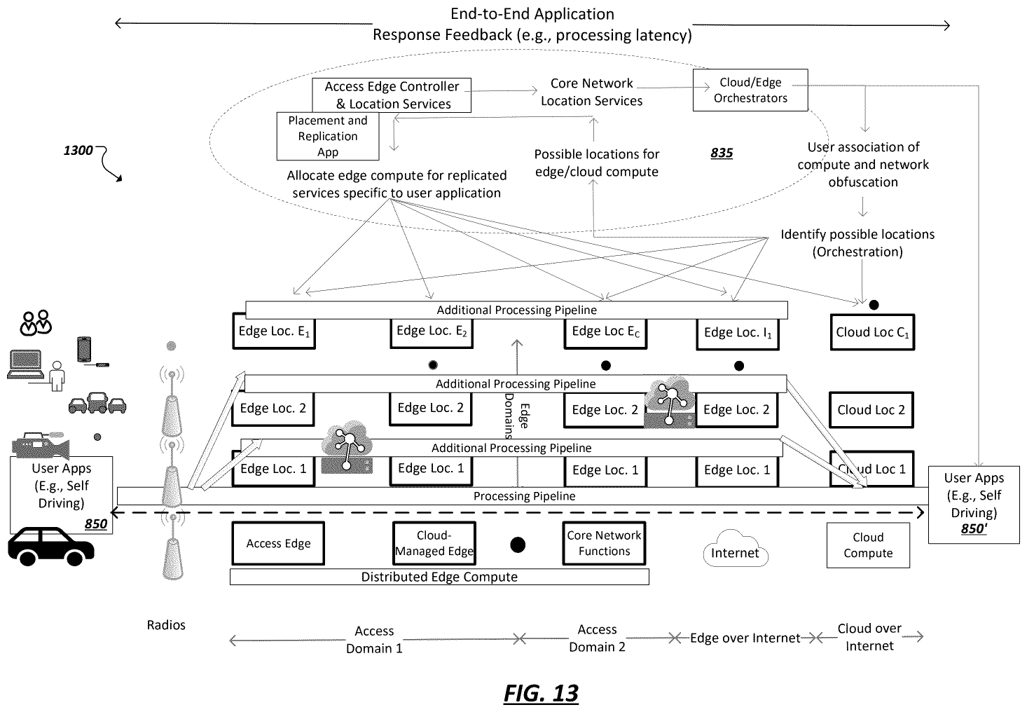

Various policies, rules, and user application preference information may be utilized to assist in determine when and how processing pipelines may be created, multiplied, or scaled down. In some implementations, a user applications (e.g., 850, 850′) (e.g., a client or cloud application) can interact with the orchestrators to indicate an end-to-end QoS service requirement for the application. Corresponding monitoring and telemetry services may be activated and configured in association with these QoS policies. For instance, the input data associated with the application may be analyzed for possible parallelization of an associated MoE workload, specific to end-to-end context. For instance, in the example of FIG. 13, a simplified block diagram 1300 is shown illustrating an example of the dynamic creation and scaling of an edge-node-implemented MoE pipeline for a given application (e.g., 850 (e.g., a self-driving application)). The orchestrator system 835 may facilitate the dynamic end-to-end creation of multiple MoE processing pipeline using edge nodes within a system. In some implementations, the policies for the data pre-processing may be generated based on learning performed by the orchestration system 835 to identify instances of independent MoE tasks that can be serialized to achieve an independent processing pipeline. The creation of processing pipelines can be tied to a data processing logic such that there is a dedicated input and output pair for each processing pipeline. The number of processing pipelines may be created and destroyed based on the close loop control, or reinforcement learning with feedback.

In one example of an edge-based MoE workload flow implementation, a particular subset of MoE expert models may be selected to implement a flow to detect faces within an image. For instance, MoE expert models can include a facial detection expert (e.g., to take a full-size image from the camera and finds the faces), a facial landmarks expert, and a reidentify face expert (e.g., where two inference actions may be performed sequentially (e.g., on the same or different edge nodes), using the image of a single face first to get landmarks and then to re-identify face using these landmarks. An age and gender attribute expert model may take a single face image and infer age and gender. A resize frame service can also be provided that takes a full-size image from the camera and resizes it (e.g., to minimize the network utilization for the visualizer). In this example, the minimum end-to-end processing is an image with no faces. Further, in this example, the full-frame input image is transmitted twice: once to fetch from the camera or other image source, and second to transmit the image data to an edge device implementing a detect faces MoE model or worker and transmit a resized version of the image to a visualizer expert model. The maximum end-to-end processing in this case would be an image with many different faces. In this maximum scenario, the full-frame image may again be transmitted twice: once to fetch from the camera, and second to transmit to a respective instance of a detect faces MoE model worker (e.g., which may be one of multiple instances of the detect faces MoE model implemented on edge nodes in the system). As such, each face may be transmitted to multiple edge nodes implementing respective MoE expert instances, yielding a high degree of parallelism, but at the expense of network utilization of face images. Also, a high number of faces may utilize an equal number of consumers or else the consumer group may queue or drop subsequent frames due to having no consumers available. The system may monitor performance telemetry for the deployed MoE edge nodes to determine whether the deployed edge nodes are being suitably utilized or whether input data is queuing, buffering, or being dropped due to insufficient edge node workers being allocated (e.g., based on a number of faces being detected in incoming image data as compared to the currently allocated inferencing compute utilization), among other examples.

Implementation of an MoE flow including multiple selected MoE expert models for a given application workload may include not only provisioning MoE expert model logic on respective edge nodes, but also configuring a data plane to be implemented among the deployed edge nodes to implement a flow (e.g., corresponding to the configuration of the MoE gating network) between the MoE expert models and one or more edge nodes tasked with generating an end result for the flow based on the combined results of the constituent MoE expert model instances. As such, an orchestrator or other system management entity may provision edge nodes with not only logic to perform appropriate input data preprocessing, MoE expert processing, and postprocessing to produce an end result, but nodes may also be provisioned with structures or instructions to determine how data is to be routed between edge nodes. Such routing may include appropriate routing of scaled or preprocessed data to respective MoE expert nodes (e.g., with particular segments adapted for use as inputs to specific ones of the expert models) and routing of the outputs of some expert models to be used as the inputs of other expert models (e.g., hosted on other edge nodes) in an MoE flow or service chain, among other examples. Further, to assist in aggregating MoE expert results for processing to generate an end result for a corresponding input, edge nodes provisioned with MoE expert model logic may also be provisioned with logic to apply tags or other metadata to result generated by the expert model to allow an edge node provisioned with postprocessing logic to identify and appropriately group expert model results that are based on given input data to generate a corresponding end result for the corresponding input data.

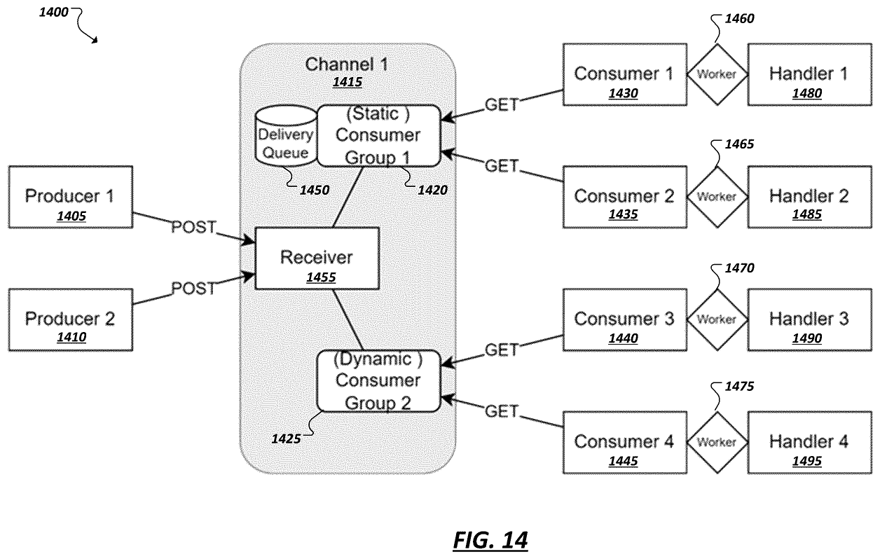

In some implementations, data pipeline data structures may be utilized to implement the data plane of the system. Such structures may facilitate the flow of messages from a producer as distributed to one or more worker process. In some implementations, the data structures may be utilized to implement communication similar to a publish-subscribe model. In some implementations, respective pipeline service instances (e.g., MoE nodes) may have the requisite code or other logic to execute all of the data structures, but the control configuration instructs each instance the processes which it utilizes. FIG. 14 is a simplified block diagram 1400 illustrating an architecture of data pipeline data structures for use in implementing an example data plane for a MoE-based edge implementation. For instance, a producer (e.g., 1405, 1410) may correspond to the generator or distributor of a given input data. Channels (e.g., 1415) may indicate the receiver and/or consumer (or consumer group (e.g., 1420, 1425) including multiple consumer nodes (e.g., 1430, 1435, 1440, 1445, etc.) (e.g., which may be statically or dynamically defined) of the input. The channel may include a delivery queue (e.g., 1450) and a receiver 1455 to receive data posted by one or more producers. A consumer (e.g., 1430, 1435, 1440, 1445) may include a messenger, a handler (e.g., 1480, 1485, 1490, 1495), and a worker (e.g., 1460, 1465, 1470, 1475). The control plan data structure may facilitate remote procedure calls to processes via a centralized mechanism. These remote procedure calls may include commands for control, configuration, telemetry, and notifications. In some implementations, the interface uses HTTP web protocols and using WebSockets and may use ASP.NET SignalR Core or other protocols enabling high performance and scalability. Control may include Start, Stop, Restart, Ping, and other messaging. Configuration may be used to apply respective settings at a node. Telemetry may include Logging, Monitoring, Observability, and other messaging. Notifications may include Process Online, Process Offline, Process Error, and other examples.

“Logic,” as used herein, may refer to hardware, firmware, software, and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, HDL, and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware devices. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing, and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, e.g., reset, while an updated value potentially includes a low logical value, e.g., set. Note that any combination of values may be utilized to represent any number of states.

The embodiments of methods, hardware, software, firmware, or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is a one non-transitory machine readable storage medium with instructions stored thereon, the instructions executable by a machine to cause the machine to: determine, for an application workload, a subset of expert models in a mixture of experts (MoE) architecture to implement the application workload; identify input data associated with the application workload; determine segmentation opportunities for the input data based on the subset of expert models; select a subset of edge nodes in a plurality of edge nodes to execute the subset of expert models; load code to implement the subset of expert models on the subset of edge nodes; cause the input data to be preprocessed to generate scaled data for the subset of expert models, where the input data is preprocessed to segment the input data based on the segmentation opportunities; and cause the scaled data to be provided to the subset of edge nodes.

Example 2 includes the subject matter of example 1, where the instructions are further executable to cause the machine to determine data post-processing to generate an end result for the application workload based on result data from the subset of expert models.

Example 3 includes the subject matter of example 2, where the instructions are further executable to cause the machine to load postprocessing logic on another one of the plurality of edge nodes to perform the data post-processing.

Example 4 includes the subject matter of any one of examples 2-3, where the result data from the subset of expert models include metadata to indicate a relationship between the result data and the input data.

Example 5 includes the subject matter of any one of examples 1-4, where the instructions are further executable to cause the machine to load preprocessing logic on at least one other edge node in the plurality of edge nodes to cause the input data to be preprocessed at the at least one other edge node to generate the scaled data, where the at least one other edge node is to distribute the scaled data to the subset of edge nodes.

Example 6 includes the subject matter of example 5, where the input data is segmented to generate a plurality of different input data segments, and the plurality of different input data segments are distributed as inputs to one or more of the subset of expert models.

Example 7 includes the subject matter of any one of examples 1-6, where the input data is to be preprocessed to transform at least a portion of the scaled data from a first format to a second format, and the portion of the scaled data is preprocessed to adapt the portion of the scaled data for consumption by a given one of the subset of expert models.

Example 8 includes the subject matter of any one of examples 1-7, where the instructions are further executable to cause the machine to: determine a service level policy to apply to the application workload; and determine resource availability in the plurality of edge nodes, where the subset of edge nodes are selected based on the service level policy and the resource availability, where code for a given expert model in the subset of expert models is to be loaded onto two or more of the subset of edge nodes to allow parallel processing of the given expert model.

Example 9 includes the subject matter of example 8, where the input data is preprocessed to duplicate at least a portion of the input data for the given expert model on the two or more of the subset of edge nodes.

Example 10 includes the subject matter of any one of examples 8-9, where the instructions are further executable to cause the machine to: collect telemetry data for the subset of edge nodes; determine performance of the subset of edge nodes based on the telemetry data; and dynamically provision additional edge nodes with code to implement additional instances of one or more of the subset of expert models on the additional edge nodes.

Example 11 includes the subject matter of any one of examples 1-9, where the input data includes image data.

Example 12 includes the subject matter of any one of examples 1-11, where respective expert models in the subset of expert models are respectively trained to perform a different inference on an input.

Example 13 includes the subject matter of any one of examples 1-12, where the instructions are further executable to cause the machine to: determine a gating network configuration for the application workload to define a flow including the subset of expert models; and configure the subset of edge nodes to pass data in the subset of edge nodes to implement the flow.

Example 14 includes the subject matter of any one of examples 1-13, where the instructions are further executable to cause the machine to determine a trend in the input data, where the segmentation opportunities are determined based on the trend and the subset of edge nodes are selected to implement parallel processing for one or more of the subset of expert models based on the trend.

Example 15 is a method including: determining a service level of an application; launching, on a plurality of edge nodes, a plurality of expert models selected from a mixture of experts (MoE) architecture; determining preprocessing to be performed on input data of the application based on the plurality of expert models, where the input data is preprocessed to generate a plurality of different versions of the input data and the plurality of different versions are adapted to inputs of the plurality of expert models; determining post-processing to be performed to convert outputs of the plurality of expert models into an end result for the application based on the input data; and dynamically launching additional instances of one or more of the plurality of expert models on one or more edge nodes based on the service level or a trend identified in the input data.

Example 16 includes the subject matter of example 15, where the plurality of different versions include different segments of the input data, and the method further includes routing the different segments to respective edge nodes in the plurality of edge nodes configured to execute corresponding expert models in the plurality of expert models.

Example 17 is a system including means to perform the method of any one of examples 15-16.

Example 18 is a method including: determining, for an application workload, a subset of expert models in a mixture of experts (MoE) architecture to implement the application workload; identifying input data associated with the application workload; determining segmentation opportunities for the input data based on the subset of expert models; selecting a subset of edge nodes in a plurality of edge nodes to execute the subset of expert models; loading code to implement the subset of expert models on the subset of edge nodes; causing the input data to be preprocessed to generate scaled data for the subset of expert models, where the input data is preprocessed to segment the input data based on the segmentation opportunities; and causing the scaled data to be provided to the subset of edge nodes.

Example 19 includes the subject matter of example 18, further including determining data post-processing to generate an end result for the application workload based on result data from the subset of expert models.

Example 20 includes the subject matter of example 19, further including loading postprocessing logic on another one of the plurality of edge nodes to perform the data post-processing.

Example 21 includes the subject matter of any one of examples 19-20, where the result data from the subset of expert models include metadata to indicate a relationship between the result data and the input data.

Example 22 includes the subject matter of any one of examples 18-21, further including loading preprocessing logic on at least one other edge node in the plurality of edge nodes to cause the input data to be preprocessed at the at least one other edge node to generate the scaled data, where the at least one other edge node is to distribute the scaled data to the subset of edge nodes.

Example 23 includes the subject matter of example 22, where the input data is segmented to generate a plurality of different input data segments, and the plurality of different input data segments are distributed as inputs to one or more of the subset of expert models.

Example 24 includes the subject matter of any one of examples 18-23, where the input data is to be preprocessed to transform at least a portion of the scaled data from a first format to a second format, and the portion of the scaled data is preprocessed to adapt the portion of the scaled data for consumption by a given one of the subset of expert models.

Example 25 includes the subject matter of any one of examples 18-24, further including: determining a service level policy to apply to the application workload; and determining resource availability in the plurality of edge nodes, where the subset of edge nodes are selected based on the service level policy and the resource availability, where code for a given expert model in the subset of expert models is to be loaded onto two or more of the subset of edge nodes to allow parallel processing of the given expert model.

Example 26 includes the subject matter of example 25, where the input data is preprocessed to duplicate at least a portion of the input data for the given expert model on the two or more of the subset of edge nodes.

Example 27 includes the subject matter of any one of examples 25-26, further including: collecting telemetry data for the subset of edge nodes; determining performance of the subset of edge nodes based on the telemetry data; and dynamically provisioning additional edge nodes with code to implement additional instances of one or more of the subset of expert models on the additional edge nodes.

Example 28 includes the subject matter of any one of examples 18-27, where the input data includes image data.

Example 29 includes the subject matter of any one of examples 18-28, where respective expert models in the subset of expert models are respectively trained to perform a different inference on an input.

Example 30 includes the subject matter of any one of examples 18-29, further including: determining a gating network configuration for the application workload to define a flow including the subset of expert models; and configuring the subset of edge nodes to pass data in the subset of edge nodes to implement the flow.

Example 31 includes the subject matter of any one of examples 18-30, further including determining a trend in the input data, where the segmentation opportunities are determined based on the trend and the subset of edge nodes are selected to implement parallel processing for one or more of the subset of expert models based on the trend.

Example 32 is a system including means to perform the method of any one of examples 18-31.

Example 33 is a system including: a processor; a memory; a set of edge nodes; and an orchestrator including instructions executable by the processor to: select, for an application workload, a subset of expert models in a mixture of experts (MoE) architecture to implement the application workload; identify input data associated with the application workload; determine segmentation for the input data based on the subset of expert models; select a subset of edge nodes in the set of edge nodes to execute the subset of expert models; load code to implement the subset of expert models on the subset of edge nodes; define a routing of data among the subset of edge nodes based on the segmentation for the input data and the selected subset of edge nodes; and determine post-processing of result data of the subset of expert models to generate an end result for the application workload based on the input data.

Example 34 includes the subject matter of example 33, where the orchestrator includes instructions executable by the processor to: load preprocessing code on one or more first edge nodes to perform preprocessing of the input data, where the preprocessing of the input data includes the segmentation of the input data; and load postprocessing code on one or more second edge nodes to perform the post-processing of the result data of the subset of expert models.

Example 35 includes the subject matter of any one of examples 33-34, where the subset of edge nodes includes a number of edge nodes selected based on segmentation for the input data, where at least one given expert model in the subset of expert models is to be implemented as multiple parallel instances of the given expert model on two or more of the number of edge nodes based on the segmentation for the input data.

Example 36 includes the subject matter of any one of examples 33-35, where the orchestrator includes instructions executable by the processor to select additional edge nodes from the set of edge nodes to dynamically implement additional instances of the subset of expert models based on attributes of the input data.

Example 37 includes the subject matter of any one of examples 33-36, where the orchestrator includes instructions executable by the processor to determine data post-processing to generate an end result for the application workload based on result data from the subset of expert models.

Example 38 includes the subject matter of example 37, where the orchestrator includes instructions executable by the processor to load postprocessing logic on another one of the plurality of edge nodes to perform the data post-processing.

Example 39 includes the subject matter of any one of examples 37-38, where the result data from the subset of expert models include metadata to indicate a relationship between the result data and the input data.

Example 40 includes the subject matter of any one of examples 33-39, where the orchestrator includes instructions executable by the processor to load preprocessing logic on at least one other edge node in the plurality of edge nodes to cause the input data to be preprocessed at the at least one other edge node to generate the scaled data, where the at least one other edge node is to distribute the scaled data to the subset of edge nodes.

Example 41 includes the subject matter of example 40, where the input data is segmented to generate a plurality of different input data segments, and the plurality of different input data segments are distributed as inputs to one or more of the subset of expert models.

Example 42 includes the subject matter of any one of examples 33-41, where the input data is to be preprocessed to transform at least a portion of the scaled data from a first format to a second format, and the portion of the scaled data is preprocessed to adapt the portion of the scaled data for consumption by a given one of the subset of expert models.

Example 43 includes the subject matter of any one of examples 33-42, where the orchestrator includes instructions executable by the processor to: determine a service level policy to apply to the application workload; and determine resource availability in the plurality of edge nodes, where the subset of edge nodes are selected based on the service level policy and the resource availability, where code for a given expert model in the subset of expert models is to be loaded onto two or more of the subset of edge nodes to allow parallel processing of the given expert model.

Example 44 includes the subject matter of example 43, where the input data is preprocessed to duplicate at least a portion of the input data for the given expert model on the two or more of the subset of edge nodes.

Example 45 includes the subject matter of any one of examples 43-44, where the orchestrator includes instructions executable by the processor to: collect telemetry data for the subset of edge nodes; determine performance of the subset of edge nodes based on the telemetry data; and dynamically provision additional edge nodes with code to implement additional instances of one or more of the subset of expert models on the additional edge nodes.

Example 46 includes the subject matter of any one of examples 33-45, where the input data includes image data.

Example 47 includes the subject matter of any one of examples 33-46, where respective expert models in the subset of expert models are respectively trained to perform a different inference on an input.

Example 48 includes the subject matter of any one of examples 33-47, where the orchestrator includes instructions executable by the processor to: determine a gating network configuration for the application workload to define a flow including the subset of expert models; and configure the subset of edge nodes to pass data in the subset of edge nodes to implement the flow.

Example 49 includes the subject matter of any one of examples 33-48, where the orchestrator includes instructions executable by the processor to determine a trend in the input data, where the segmentation opportunities are determined based on the trend and the subset of edge nodes are selected to implement parallel processing for one or more of the subset of expert models based on the trend.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplary language does not necessarily refer to the same embodiment or the same example, but may refer to different and distinct embodiments, as well as potentially the same embodiment.

What is claimed is:

1. At least one non-transitory machine readable storage medium with instructions stored thereon, the instructions executable by a machine to cause the machine to:
determine, for an application workload, a subset of expert models in a mixture of experts (MoE) architecture to implement the application workload;
identify input data associated with the application workload;
determine segmentation opportunities for the input data based on the subset of expert models;
select a subset of edge nodes in a plurality of edge nodes to execute the subset of expert models;
load code to implement the subset of expert models on the subset of edge nodes;
cause the input data to be preprocessed to generate scaled data for the subset of expert models, wherein the input data is preprocessed to segment the input data based on the segmentation opportunities; and
cause the scaled data to be provided to the subset of edge nodes.

2. The storage medium of claim 1, wherein the instructions are further executable to cause the machine to determine data post-processing to generate an end result for the application workload based on result data from the subset of expert models.

3. The storage medium of claim 2, wherein the instructions are further executable to cause the machine to load postprocessing logic on another one of the plurality of edge nodes to perform the data post-processing.

4. The storage medium of claim 2, wherein the result data from the subset of expert models comprise metadata to indicate a relationship between the result data and the input data.

5. The storage medium of claim 1, wherein the instructions are further executable to cause the machine to load preprocessing logic on at least one other edge node in the plurality of edge nodes to cause the input data to be preprocessed at the at least one other edge node to generate the scaled data, wherein the at least one other edge node is to distribute the scaled data to the subset of edge nodes.

6. The storage medium of claim 5, wherein the input data is segmented to generate a plurality of different input data segments, and the plurality of different input data segments are distributed as inputs to one or more of the subset of expert models.

7. The storage medium of claim 1, wherein the input data is to be preprocessed to transform at least a portion of the scaled data from a first format to a second format, and the portion of the scaled data is preprocessed to adapt the portion of the scaled data for consumption by a given one of the subset of expert models.

8. The storage medium of claim 1, wherein the instructions are further executable to cause the machine to:
determine a service level policy to apply to the application workload; and
determine resource availability in the plurality of edge nodes, wherein the subset of edge nodes are selected based on the service level policy and the resource availability, wherein code for a given expert model in the subset of expert models is to be loaded onto two or more of the subset of edge nodes to allow parallel processing of the given expert model.

9. The storage medium of claim 8, wherein the input data is preprocessed to duplicate at least a portion of the input data for the given expert model on the two or more of the subset of edge nodes.

10. The storage medium of claim 8, wherein the instructions are further executable to cause the machine to:
collect telemetry data for the subset of edge nodes;
determine performance of the subset of edge nodes based on the telemetry data; and
dynamically provision additional edge nodes with code to implement additional instances of one or more of the subset of expert models on the additional edge nodes.

11. The storage medium of claim 1, wherein the input data comprises image data.

12. The storage medium of claim 1, wherein respective expert models in the subset of expert models are respectively trained to perform a different inference on an input.

13. The storage medium of claim 1, wherein the instructions are further executable to cause the machine to:
determine a gating network configuration for the application workload to define a flow comprising the subset of expert models; and
configure the subset of edge nodes to pass data in the subset of edge nodes to implement the flow.

14. The storage medium of claim 1, wherein the instructions are further executable to cause the machine to determine a trend in the input data, wherein the segmentation opportunities are determined based on the trend and the subset of edge nodes are selected to implement parallel processing for one or more of the subset of expert models based on the trend.

15. A method comprising:
determining a service level of an application;
launching, on a plurality of edge nodes, a plurality of expert models selected from a mixture of experts (MoE) architecture;
determining preprocessing to be performed on input data of the application based on the plurality of expert models, wherein the input data is preprocessed to generate a plurality of different versions of the input data and the plurality of different versions are adapted to inputs of the plurality of expert models;
determining post-processing to be performed to convert outputs of the plurality of expert models into an end result for the application based on the input data; and
dynamically launching additional instances of one or more of the plurality of expert models on one or more edge nodes based on the service level or a trend identified in the input data.

16. The method of claim 15, wherein the plurality of different versions comprise different segments of the input data, and the method further comprises routing the different segments to respective edge nodes in the plurality of edge nodes configured to execute corresponding expert models in the plurality of expert models.

17. A system comprising:
a processor;
a memory;
a set of edge nodes; and
an orchestrator comprising instructions executable by the processor to:
select, for an application workload, a subset of expert models in a mixture of experts (MoE) architecture to implement the application workload;
identify input data associated with the application workload;
determine segmentation for the input data based on the subset of expert models;
select a subset of edge nodes in the set of edge nodes to execute the subset of expert models;
load code to implement the subset of expert models on the subset of edge nodes;
define a routing of data among the subset of edge nodes based on the segmentation for the input data and the selected subset of edge nodes; and
determine post-processing of result data of the subset of expert models to generate an end result for the application workload based on the input data.

18. The system of claim 17, wherein the orchestrator comprises instructions executable by the processor to:
load preprocessing code on one or more first edge nodes to perform preprocessing of the input data, wherein the preprocessing of the input data comprises the segmentation of the input data; and
load postprocessing code on one or more second edge nodes to perform the post-processing of the result data of the subset of expert models.

19. The system of claim 17, wherein the subset of edge nodes comprises a number of edge nodes selected based on segmentation for the input data, wherein at least one given expert model in the subset of expert models is to be implemented as multiple parallel instances of the given expert model on two or more of the number of edge nodes based on the segmentation for the input data.

20. The system of claim 17, wherein the orchestrator comprises instructions executable by the processor to select additional edge nodes from the set of edge nodes to dynamically implement additional instances of the subset of expert models based on attributes of the input data.
